(19) United States
(12) Patent Application Publication
(10) Pub. No.: US 2009/0240658 A1
(43) Pub. Date: Sep. 24, 2009

(54) Search button on input device

(76) Inventor: Alex You-Jen Chang, Taipei City (TW)

Correspondence Address: BAKER & MCKENZIE LLP;PATENT DEPARTMENT, 2001 ROSS AVENUE, SUITE 2300, DALLAS, TX, 75201, US

(21) Appl. No.: 12/052,344

(22) Filed: Mar. 20, 2008

(51) Int. Cl. G06F 7/00

(52) U.S. Cl. 707/3

(57) ABSTRACT

Search button is a dedicated button that a user can press to perform search on a computer system input device. When a user finds a string of text on the screen that user would like to search, the current browser window or a new browser window pops up with the search result of the selected text with the press of the search button. This allows a user to navigate the web simply with the pointing input device and get the results from search engine without the need to retype the words. By using firmware, the search button performs function identifiable by the computer system; therefore no additional driver is required.

### FIELD OF INVENTION

The present invention relates to a search function button on a mouse, track ball, or a touch pad. With this button, users may obtain search results without having to type the words in the search engine.

### BACKGROUND OF THE INVENTION

The present invention relates to pointing input devices for computer systems that are used to move cursor on the screen. In many computer systems, users can control functions and select display items by using a pointing device such as a mouse, track ball or touch pad. Information about the state of the pointing input device, such as cursor movement and the activation of the switches on the input device is exchanged periodically between the computer system and the input device. The data packets from input device is generally received by software programs known as drivers, that works between the hardware of the input device and the operating system of the computer.

Currently, most pointing input devices come with two buttons, with exception such as the Apple mouse that only has one button. It has been made possible to implement more than two buttons on a pointing input device in such a way that additional functions can be invoked from currently available applications by pressing one of the additional buttons.

Navigating the web has been used primarily with the pointing input device such as mouse, track ball, or touch pad. However, the web search engines require user to enter text via keyboard to perform search, which pointing input devices can not operate alone. There is a need to enhance the capability of the pointing input device to include the search function. It is also in the interest of the users to conveniently gain search results from just using the pointing input device.

### SUMMARY OF THE INVENTION

It is an object of the present invention to provide a pointing input device with a search button, in which the button signal performs a combination of functions that the operating system can identify by using firmware without the need for additional driver installed on the operating system. This capability enhancement is to combine several functions in one button click resulting convenient access to more information on the Internet.

In accordance with an aspect of the present invention, there is provided a pointing input device with a search button. The pointing input device can communicate with an operating system of a computer and comprises a case, one primary button, one secondary button, one search button, a switch and a button signal simulation module. The button signal simulation module is disposed within the case for converting the signals identifiable by the operating system.

In an embodiment, the button signal simulation module is implemented by firmware in the control circuit and the operating system executes the following commands in sequence: a copy command, an open default browser window command to the preset search engine web page, the paste command, and the enter command.

The objects and advantages of the present invention will become more readily apparent to those ordinarily skilled in the art after reviewing the detailed description and accompanying drawings.

### BRIEF DESCRIPTION OF THE DRAWINGS

FIG. 1 is a plan view of an operating environment according to the present invention.

FIG. 2 is a perspective view of the present invention on a laptop computer

FIG. 3 is a perspective view of a hand holding a mouse type pointing input device according to the present invention.

FIG. 4 is a side view of a mouse type pointing input device according to the present invention.

FIG. 5 is a perspective view of a hand handling a touch pad type pointing input device according to the present invention

FIG. 6 is a top view of a touch pad type pointing input device according to the present invention

FIG. 7 is a flow diagram according to the present invention.

### DETAILED DESCRIPTION OF THE INVENTION

FIG. 1 is intended to provide a brief description of a suitable computing environment in which the invention is operated. The invention carries out program modules to be executed by a personal computer. Those skilled in the art will appreciate that the invention works with other computer system configuration, including personal handheld devices, multi-processor systems, microprocessor based or customized consumer electronics, network PCs, mini computer, mainframe computers, and etc. The invention also works in the distributed computing environments where tasks are performed by remote processing powers that are linked through a communication network.

The computer system 1000 of FIG. 1 comprises of Operating System (OS) 120, display system 124, browser application 121, network interface 125, other hardware 130, driver 123, and peripheral device interface 122 that connects to the pointing input device 1 10. The computer system 1000 connects to the internet 150 and the search engine 160 through the network interface 125.

The operating system 120 may be any of the following that includes but not limited to Microsoft Windows 2000, Microsoft Windows XP, Microsoft Windows Vista, Mac OS, and Linux.

The browser application 121 is the Internet browser application that user sets as default on the operating system 120. Such browser application 121 may be any of the following that includes but not limited to Microsoft Internet Explorer, AOL explorer, Mozilla Firefox, Netscape Navigator, Opera, or Apple Safari.

The search engine 160 may be any of the following that includes but not limited to Google, Yahoo, Baidu, MSN, NHN, Ebay, AOL, Ask.com, Yandex, Alibaba, ODP, and Sogou.

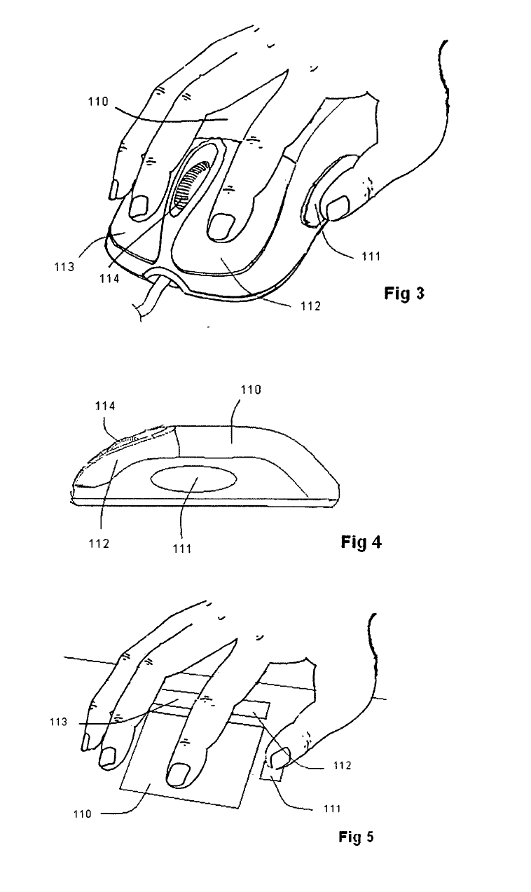

In FIGS. 1, 3 and 4, the pointing input device 110 in the case of the mouse comprises of a search button 111, a case 119, the primary button 112, secondary button 113, the scroll wheel 114, a switch 115, and a control circuit 116. The primary button 112 and secondary button 113 have the same functions as the left and right buttons of the conventional mouse. The search button 111 is positioned to be easily accessible by press of the thumb.

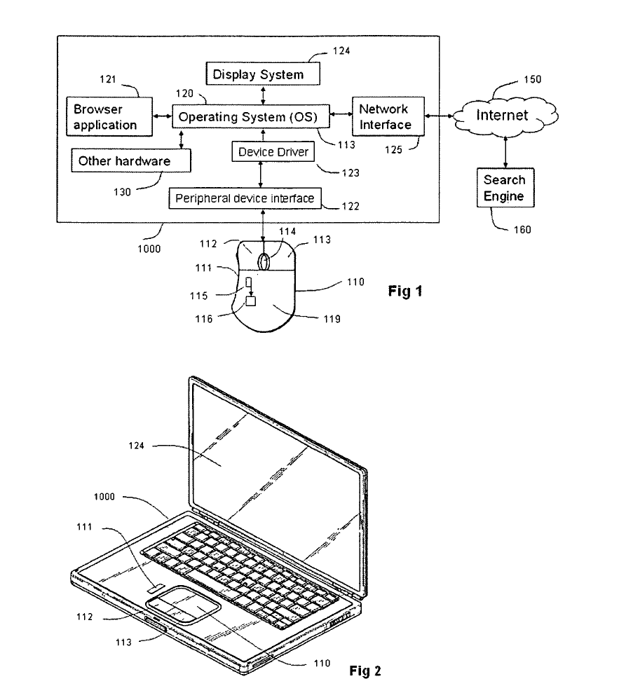

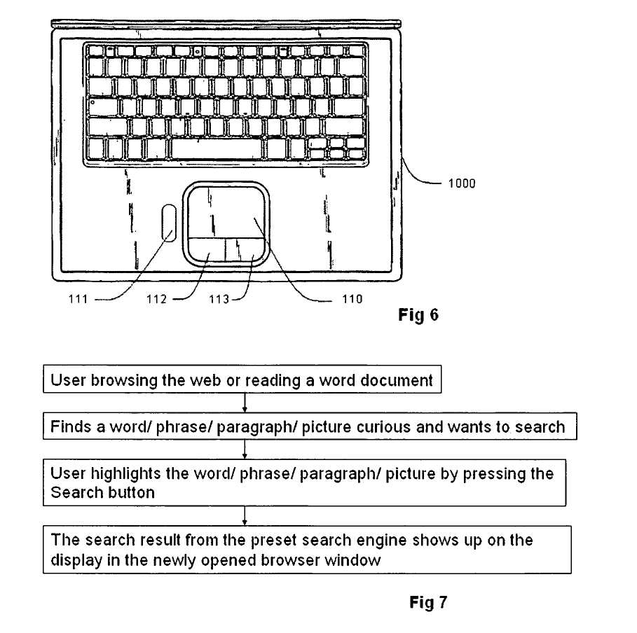

In FIGS. 2, 5 and 6, the pointing input device 110 in the case of the touch pad comprises of a search button 111, a primary button 112 and a secondary button 113 that rest on top of the computer system 1000 main body. The switch 115 and a control circuit 116 are hidden beneath the input device 110. The primary button 112 and secondary button 113 have the same functions as the left and right buttons of the conventional touch pad. The search button 111 is positioned to be easily accessible by press of the thumb.

The process flow of FIG. 7 is described in detail below. A user can highlight text and graphics by using the search button 111 the same way as the primary button 112 when pressed and held across text or graphics that user sees on the display system 124. When there is text or graphics highlighted by using search button 111, as the pressing of the search button 111 is released, the switch 115 is triggered to activate the signals in the control circuit 11 6. Control circuit 116 first sends the signal copy (Ctrl +C) of the highlighted text to the Operating System 120. Subsequently, control circuit 116 sends the signal to Operating System 120 to open a new default browser window 121 with the preset search engine 160 web page. Then, control circuit 116 sends the signal paste (Ctrl+V) of the highlighted text to the default browser 121 and the enter command on the search engine 160 web page. Lastly, search engine 160 returns the search result and shows on the display system 124. If the text is highlighted by using the primary button 112, a subsequent click of the search button 111 also returns the same result as described above.

The button signal module is implemented by firmware provided in the control circuit 116. Therefore it is not necessary to install additional device driver. The control circuit 116 also stores unique device identification number.

Although only one search button 111 shape is shown above, other button location and shapes are within the scope of the invention and include shapes that with more or less edges or level of protrusion.

Although the present invention has been described with reference to a right handed pointing input device, those skilled in the art will recognize that a left handed pointing input device is within the spirit of the invention. A left handed pointing input device of the present invention would be a mirror image of the right handed pointing input device described above.

Although the present invention has been described with reference to particular embodiments, workers skilled in the art will recognize that changes may be made in form and detail without departing from the spirit and scope of the invention.

What is claimed is

1. An input device for a computer system comprises a search button capable of returning search results with a click of said button.

2. The input device for a computer system of claim 1, wherein the input device is a mouse, a track ball or a touch pad.

3. An input device for a computer system comprises:
a casing;
a search function button capable of returning search results with a click of said button;
a switch disposed within said case and can be triggered to generate button signals;
a control circuit that holds execution commands;
a button signal simulation module;
a primary button; and
a secondary button.

4. The input device for a computer system of claim 3, wherein said input device is a touch pad on a laptop computer.

5. The input device for a computer system of claim 3, further comprise a wired or wireless connection to the computer.

6. The input device for a computer system of claim 5, wherein said input device is a mouse, a detached touch pad or a detached track ball.

7. The input device for a computer system of claim 3, wherein said search function button is located at an area that can be easily accessed by user's thumb.

8. The input device for a computer system of claim 3, wherein said button signal simulation module is implemented by firmware.

9. The input device for a computer system of claim 3, wherein said execution commands comprises:
a copy command;
a open default browser window command that opens a preset search engine web page;
a paste command; and
a enter command.

10. The input device for a computer system of claim 9, wherein said execution commands are in the forms of combination of signal message activities.

11. The input device for a computer system of claim 3, further comprises a unique built in device identification number (DIN) that allows said input device be identified by a computer system, a network and a search engine.

12. The input device for a computer system of claim 1, wherein said search results are displayed on a current browser window.

13. The input device for a computer system of claim 1, wherein said search results are displayed on a newly opened browser window.

14. The input device for a computer system of claim 1, wherein said search button is a touch sensitive button to simulate a click. 7
